(19) United States
(12) Patent Application Publication
(10) Pub. No.: US 2012/0013711 A1
(43) Pub. Date: Jan. 19, 2012

(54) METHOD AND SYSTEM FOR CREATING THREE-DIMENSIONAL VIEWABLE VIDEO FROM A SINGLE VIDEO STREAM

(75) Inventors: Michael Tamir, Tel Aviv (IL); Itzhak Wilf, Yehud-Monoson (IL)

(73) Assignee: Stergen Hi-Tech Ltd., Tel-Aviv (IL)

(21) Appl. No.: 13/203,980

(22) PCT Filed: Apr. 7, 2010
(86) PCT No.: PCT/IB10/51500

§ 371 Date: Aug. 31, 2011

Related U.S. Application Data
(60) Provisional application No. 61/202,803, filed on Apr. 8, 2009.

(51) Int. Cl. H04N 13/02

(52) U.S. Cl. 348/46; 348/E13.003

(57) ABSTRACT

It is provided a method for generating a 3D representation of a scene, initially represented by a first video stream captured by a certain camera at a first set of viewing configurations. The method includes providing video streams compatible with capturing the scene by cameras, and generating an integrated video stream enabling three-dimensional display of the scene by integration of two video streams. The method includes calculating parameters characterizing a viewing configuration by analysis of elements having known geometrical parameters. The scene may be a sport scene which a playing field, a group of on-field objects and a group of background objects. The method includes segmenting a frame to those portions, separately associating each portion to the different viewing configuration, and merging them into a single frame. Also, the method may include calculating of on-field footing locations of on-field objects, computing new locations in a new frame, and transforming the on-field objects to the respective frame as a 2D object. Furthermore, the method may include synthesizing at on-field objects by segmenting portions of the object from respective frames of the first video stream, stitching the portions together and rendering the stitched object within a synthesized frame.

### BACKGROUND OF THE INVENTION

1. Field of the Invention

The invention is in the field of three dimensional (3D) real time and offline video production and more particularly stereo and multi-view synthesis for 3D production of sports events.

2. Description of Related Art

The use of 3D productions in theatres and home television is spreading out. Some studies indicate that there are about 1,300 3D equipped theaters in the U.S. today and that the number could grow to 5,000 by the end of 2009. The study, “3-D TV: Where are we now and where are consumers” shows that 3D technology is positioned to become a major force in future in-home entertainment. As with many successful technologies, such as HDTV, interest in 3D increases as consumers experience it first-hand. In 2008, nearly 41 million U.S. adults report having seen a 3D movie in theaters. Of those, nearly 40% say they would prefer to watch a movie in 3D than in 2D, compared to just 23 percent who have not seen a 3D movie in 2008.

The study also found that present 3D technology is becoming a major purchasing factor of TV sets. 16% percent of consumers are interested in watching 3D movies or television shows in their home, while 14% are interested in playing 3D video games. All told, more than 26 million households are interested in having a 3-D content experience in their own home. More than half of U.S. adults said having to wear special glasses or hold their heads still while watching a 3D TV would have no impact on them purchasing a 3D set for their home.

The 3D experience is probably much more intense and significant than prior broadcast revolutions such as black/white to color and the move to HDTV. As usual, sports productions are at the forefront of the 3D revolution as with all prior innovations. There are many examples to that:
Sony Electronics has struck a deal with Fox Sports to sponsor the network's 3D HD broadcast of the FedEx Bowl Championship Series (BCS) college football national championship game.
In 2008, for the very first time at Roland Garros, Orange was going to film and broadcast live its first 3D sports contents for its guests.
BBC engineers have broadcasted an entire international sporting event live in 3D for the first time in the UK, as Scotland's defeat of England in the Six Nations rugby union championship was relayed to a London cinema audience.
2008's IBC show saw Wige data, a big European sports producing company entering the 3D fray. Joining forces with fellow German manufacturer MikroM and 3D rig specialist 3ality, Wige demonstrated a 3D wireless bundle which combines its CUNIMA MCU camera, MikroM's Megacine field recorder and a 3ality camera rig.
Speaking at the Digital TV Group's annual conference, Sky's Chief engineer Chris Johns revealed: ‘At the moment we are evaluating all of the mechanisms to deliver 3D, and are building a content library of 3D material for the forthcoming year.’

Johns confirmed delivery will be via the current Sky+ HD set top box, but says viewers will need to buy ‘a 3D capable TV’ to enjoy the service. He added: ‘When sets come to market, we want to refine 3D production techniques and be in a position to deliver first generation, self-generated 3D content.’
The US National Football League has been broadcasted live in 3D few games demonstrating that the technology can be used to provide a more realistic experience in a theater or in the home.

Vendors of TV sets are already producing “3D ready” sets, some are based on eyeglasses technologies [see ref. 1] wherein the viewers are wearing polarization or other types of stereo glasses. Such TV sets require just two different stereoscopic views. Other 3D sets are auto-stereoscopic [see ref. 2] and as such require multiple views (even 9 views for each frame!) to serve multiple viewers that watch television together.

There are several technologies for auto-stereoscopic 3D displays. Presently, most flat-panel solutions employ lenticular lenses or parallax barriers that redirect incoming imagery to several viewing regions at a lower resolution. If the viewer positions his/her head in certain viewing positions, he/she will perceive a different image with each eye, giving a stereo image. Such displays can have multiple viewing zones allowing multiple users to view the image at the same time. Some flat-panel auto-stereoscopic displays use eye tracking to automatically adjust the two displayed images to follow viewers' eyes as they move their heads. Thus, the problem of precise head-positioning is ameliorated to some extent.

The 3D production is logistically complicated. Multiple cameras (two in the case of a dual-view, multiple in the case of a multi-view production) need to be boresighted (aligned together), calibrated and synchronized. Bandwidth requirements are also much higher in 3D.

Naturally these difficulties are enhanced in the case of outdoor productions such as coverage of sports events. Additionally, all the stored and archived footage of the TV stations is in 2D.

It is therefore the purpose of the current invention to offer a system and method to convert a single stream of conventional 2D video into a dual view or multi-view 3D representations for both archived sports footage as well as live events. It is our basic assumption that the converted footage should be in a very high quality and should adhere to the standards of the broadcast industry.

Existing automatic 2D to 3D conversion methods create depth maps using cues such as objects motion, occlusion and other features [3,4]. According to our best judgment these methods cannot provide the quality required by broadcasters nor the synthesis of multiple views required in a multi-view 3D display.

### List of Prior Art Publications(Hereafter References or Ref.):

1. “Samsung unveils world's 1^{st} 3D plasma TV”, The Korea Times, Biz/Finance, Feb. 2, 2008.
2. http://www.obsessable.com/news/2008/10/02/philips-exhibits-56-inch-autostereoscopic-quad-hd-3d-tv/3.
3. M. Pollefeys, R. Koch, M. Vergauwen, L. Van Gool, “Automated reconstruction of 3D Scenes from Sequences of Images”, ISPRS Journal of Photogrammetry and Remote Sensing (55) 4, pp. 251-267, 2000.
4. C. Tomasi, T. Kanade, “Shape and Motion from Image Streams: A Factorization Method”, Journal of Computer Vision 9(2), pp. 137-154, 1992.
5. “Methods of scene change detection and fade detection for indexing of video sequences”, Inventors: Divakaran, Ajay; Sun, Huifang; Ito, Hiroshi; Poon, Tommy C.; Assignee: Mitsubishi Electric Research Laboratories, Inc. (Cambridge, Mass.).
6. “Digital chromakey apparatus”, U.S. Pat. No. 4,488,169 to Kaichi Yamamoto.
7. “Keying methods for digital video”, U.S. Pat. No. 5,070,397, to Thomas Wedderburn-Bisshop.
8. “Block matching-based method for estimating motion fields”, U.S. Pat. No. 6,285,711 to Krishna Ratakonda, M. Ibrahim Sezan.
9. “Pattern recognition system”, U.S. Pat. No. 4,817,171 to Frederick W. M. Stentiford.
10. “Image recognition edge detection method and system”, U.S. Pat. No. 4,969,202 to John L. Groezinger.
11. “Tracking players and a ball in video image sequences and estimating camera parameters for soccer games”, Yamada, Shirai, Miura, dept. of computer controlled mechanical systems, Osaka university.
12. “Optical flow detection system”, U.S. Pat. No. 5,627,905 to Thomas J. Sebok, Dale R. Sebok.
13. “Enhancing a video of an event at a remote location using data acquired”, U.S. Pat. No. 6,466,275 to Stanley K. Honey, Richard H. Cavallaro, Jerry N. Gepner, James R. Gloudemans, Marvin S. White.
14. “System and method for generating super-resolution-enhanced mosaic”, U.S. Pat. No. 6,434,280 to Shmuel Peleg, Assaf Zomet.

### BRIEF SUMMARY OF THE INVENTION

It is provided according to some embodiments of the present invention, a method for generating a three-dimensional representation of a scene. The scene is represented by a first video stream captured by a certain camera at a first set of viewing configurations. The method includes providing video streams compatible with capturing the scene by cameras, and generating an integrated video stream enabling three-dimensional display of the scene by integration of two video streams, the first video stream and one of the provided video streams, for example. The sets of viewing configurations related to the two video streams are mutually different.

A viewing configuration of a camera capturing the scene is characterized by parameters like parameters of geographical viewing direction, parameters of geographical location, parameters of viewing direction relative to elements of the scene, parameters of location relative to elements of the scene, and lens parameters like zooming or focusing parameters.

In some embodiments, parameters characterizing a viewing configuration of the first camera are measured by devices like encoders mounted on motion mechanisms of the first camera, potentiometers mounted on motion mechanisms of the first camera, a global positioning system device, an electronic compass associated with the first camera, or encoders and potentiometers mounted on camera lens.

In some embodiments, the method includes the step of calculating parameters characterizing a viewing configuration by analysis of elements of the scene as captured by the certain camera in accordance with the first video stream.

In some embodiments, the method includes determining a set of viewing configuration different from the respective set of viewing parameters associated with the first video stream. Alternatively, a frame may be synthesized directly from a respective frame of the first video stream by perspective transformation of planar surfaces.

Known geometrical parameters of the certain element are used for calculating the viewing configuration parameters. For example, a sport playing field is a major part of the scene, and its known geometrical parameters are used for calculating viewing configuration parameters. A pattern recognition technique may be used for recognizing a part of the sport playing field.

In some embodiments, the method includes identifying global camera motion during a certain time period, calculating parameters of the motion, and characterizing viewing configuration relating to a time within the certain time period based on characterized viewing configuration relating to another time within the certain time period.

In some embodiments, the method includes the step of shaping a video stream such that a viewer sense s a three dimensional scene upon integrating the video streams and displaying the integrated video stream to the viewer having corresponding viewing capability. In one example, the shaping is effecting spectral content and the viewer has for each eye one a different color glass. In other example the shaping is effecting polarization, and the viewer has for each eye a different polarizer glass. In another example, known as “active shutter glasses”, shaping refers to displaying left and right eye images in an alternating manner on a high frame rate display, and using suitable active glasses that switch the left and right eye filters, on and off in synchronization with the display. For that, the consecutive frames of at least two video streams are arranged alternately in accordance with appropriate display and view system.

In some embodiments, the first camera captures the first video stream while in motion, and one of the integrated video streams is a video stream captured by the first camera at timing shifted relative to the first video stream. Thus, the generated video stream includes superimposed video streams representative of different viewing configurations at a time.

In some embodiments, the method includes synthesizing frames of a video stream by associating a frame of the first video stream having certain viewing configuration to a different viewing configuration. The contents of the frame of the first video stream are modified to fit the different viewing configuration, and the different viewing configuration is selected for enabling three-dimensional display of the scene. The method may include the step of segmenting an element of the scene appearing in a frame from a rest portion of a frame. Such segmenting is facilitated chromakeying, lumakeying, or dynamic background subtraction, for example.

In some embodiments, the scene is a sport scene including a playing field, a group of on-field objects and a group of background objects. The method includes segmenting a frame to the playing field, the group of on-field objects and the group of background objects, separately associating each portion to the different viewing configuration, and merging them into a single frame.

Also, the method may include the steps of calculating of on-field footing locations of on-field objects in a certain frame of the first video stream, computing of on-field footing locations of on-field objects in a respective frame associated with a different viewing configuration, and transforming the on-field objects from the certain frame to the respective frame as a 2D object.

Furthermore, the method may include synthesizing at least one object of the on-field objects by the steps of segmenting portions of the object from respective frames of the first video stream, stitching the portions of the object together to fit the different viewing configuration, and rendering the stitched object within a synthesized frame associated with the different viewing configuration.

In some embodiments, a playing object is used in the sport scene and the method includes the steps of segmenting the playing object, providing location of the playing object, and generating a synthesized representation of the playing object for merging into a synthesized frame fitting the different viewing configuration.

In some embodiments, an angle between two scene elements is used for calculating the viewing configuration parameters. Similarly an estimated height of a scene element may be used for calculating the viewing configuration parameters. Relevant scene elements are players, billboards and balconies.

In some embodiments, the method includes detecting playing field features in a certain frame of the first video stream. Upon absence of sufficient feature data for the detecting, other frames of the first video stream are used as a source of data to facilitate the detecting.

It is provided according to some embodiments of the present invention, a system for generating a three-dimensional representation of a scene. The system includes a synthesizing module, and a video stream integrator. The synthesizing module provides video streams compatible with capturing the scene by cameras. Each camera has a respective set of viewing configurations different from the first set of viewing configurations. The video stream integrator generates an integrated video stream enabling three-dimensional display of the scene by integration of two video streams, the first video stream and one provided video streams, for example.

In some embodiments, the system includes a camera parameter interface for receiving parameters characterizing a viewing configuration of the first camera from devices relating to the first camera.

In some embodiments, the system includes a viewing configuration characterizing module for calculating parameters characterizing a viewing configuration by analysis of elements of the scene as captured by the certain camera in accordance with the first video stream.

In some embodiments, the system includes a scene element database and a pattern recognition module adapted for recognizing a scene element based on data retrieved from the scene element database and calculate viewing configuration parameters in accordance with the recognizing and the element data.

In some embodiments, the system includes a global camera motion module adapted for identifying global camera motion during a certain time period, calculating parameters of the motion, characterizing viewing configuration relating to a time within the certain time period based on characterized viewing configuration relating to another time within the certain time period, and time shifting a video stream captured by the first camera relative to the first video stream, such that the generated video stream including superimposed video streams having different viewing configurations at a time.

In some embodiments, the system includes a video stream shaping module for shaping a video stream for binocular 3D viewing. It also may include a segmenting module for segmenting an element of the scene appearing in a frame from a rest portion of a frame.

The system, or a part of the system, may be located in a variety of places, near the first camera, in a broadcast studio, or in close vicinity of a consumer viewing system. The system may be implemented on a processing board comprising a field programmable gate array, or a digital signal processor.

It is provided according to some embodiments of the present invention, a method for generating a three-dimensional representation of a scene including at least one element having at least one known spatial parameter. The method includes extracting parameters of the first set of viewing configurations using the known spatial parameter of the certain element, and calculating intermediate set of data relating to the scene based on the first video stream, and on the extracted parameters of the first set of viewing configurations. The intermediate set of data may include depth data of elements of the scene. The method may also include using the intermediate set of data for synthesizing video streams compatible with capturing the scene by cameras, and generating an integrated video stream enabling three-dimensional display of the scene by integration of two video streams, the first video stream and one synthesized video stream, for example. The sets of viewing configurations related to the two video streams are mutually different.

In some embodiments, tasks are divided between a server and a client and the method includes providing the intermediate set of data to a remote client, which uses the intermediate set of data for providing video streams compatible with capturing the scene by cameras, and generates an integrated video stream enabling three-dimensional display of the scene by integration of two video streams having mutually different sets of viewing configurations.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1a is a block diagram of a system for generating 3D video streams.

FIG. 1b schematically illustrates a real camera and a virtual camera viewing a scene to get a 3D representation of the scene.

FIG. 2 is a flow chart of a method for generating a 3D representation of a scene.

FIG. 3 is a flow chart of a method for generating a 3D display using a moving camera.

FIG. 4 is a block diagram of a system for generating 3D video streams of a sport scene.

FIG. 5 illustrates segmenting portions of a sport scene, synthesizing the portions and merging them.

FIG. 6a is a flow chart of a method for on-field objects.

FIG. 6b is a flow chart of a method for an object made of portions from several frames.

FIG. 7 is a flow chart of a method used in generating 3D video streams of a sport event.

FIG. 8a illustrates pattern recognition of a scene element.

FIG. 8b illustrates a playing field used in the pattern recognition of FIG. 8a.

FIG. 9 is a flow chart of a server method for generating 3D video streams in cooperation of a server and a client.

FIG. 10 is a flow chart of a client method for generating 3D video streams in cooperation of a server and a client.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described device is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereat are used to indicate that the object or objects of the verb are not necessarily a complete listing of members, components, elements or parts of the subject or subjects of the verb.

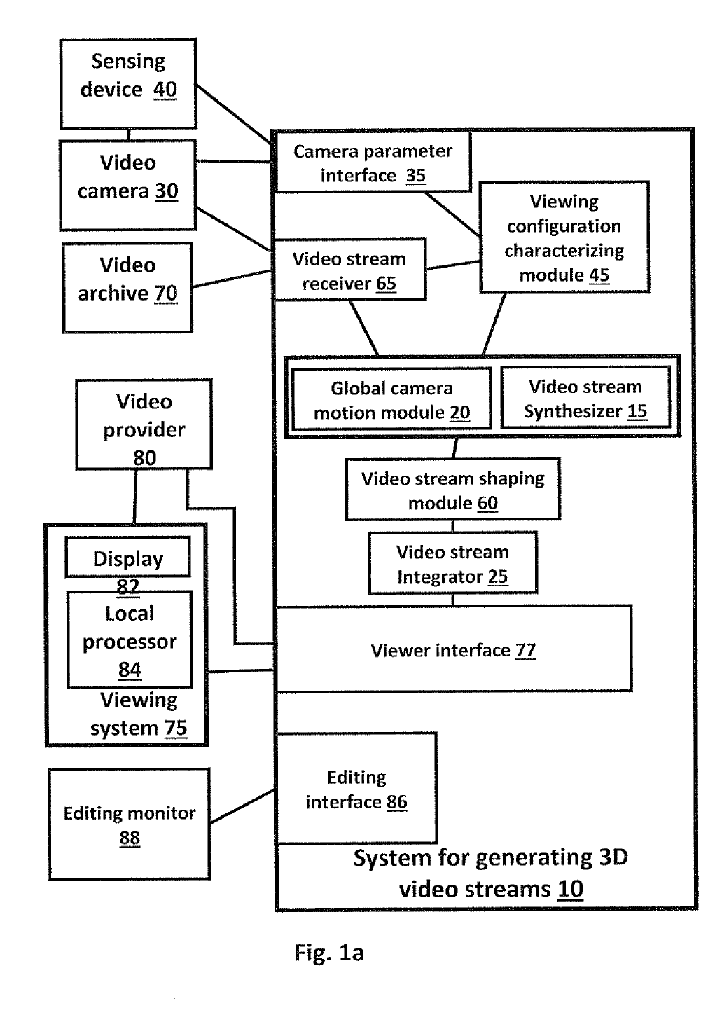

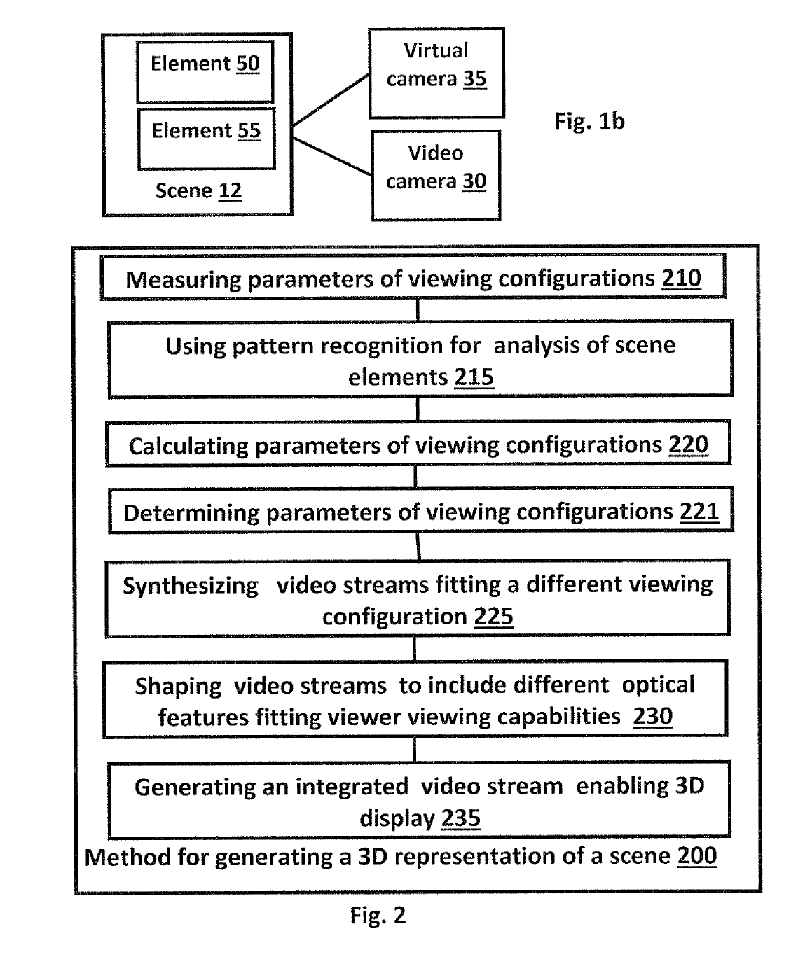

### A System and Method Embodiment for Generating 3D Video Streams (FIGS. 1-2)

It is provided a system 10, as shown in FIG. 1a and FIG. 1b, for generating a 3D representation of a scene 12. System 10 includes a synthesizing module 15, and a video stream integrator 25. Scene 12 is represented by a first video stream captured by a certain camera 30 at a first set of viewing configurations. Synthesizing module 15 provides video streams compatible with capturing scene 12 by a virtual camera 35 of FIG. 1b, having a respective set of viewing configurations different from the first set of viewing configurations. Video stream integrator 25 generates an integrated video stream enabling three-dimensional display of the scene by integration of two video streams. In one example the two video streams are the first video stream and one provided video streams. In another example, they both are provided video stream having different sets of viewing configurations.

In an example, camera 30 is a fixed camera at a first location and a first viewing direction in relation to a central point at scene 12. Virtual camera 35 is also a fixed camera having a second location at a lateral distance of 30 cm from the first location of camera 30, and having a viewing direction from the second location to the same central point of scene 12, or parallel to the first viewing direction. Thus, the set of viewing configurations of the first video stream includes a viewing configuration which is different from a repeating viewing configuration of the provided video stream, linked to virtual camera 35.

A viewing configuration of camera 30 capturing scene 12 is characterized by parameters like viewing direction relative to earth, geographical location, viewing direction relative to elements of the scene, location relative to elements of the scene, and zooming parameters or lens parameters. Note that viewing direction and location in any reference system may be each represented by three values, xyz for location, for example.

System 10 includes a camera parameter interface 30 for receiving parameters characterizing a viewing configuration of the first camera from devices or sensors 40 relating to camera 30. Exemplary devices are encoders mounted on motion mechanisms of camera 30, potentiometers mounted on motion mechanisms thereof, a global positioning system (GPS) device, or an electronic compass associated with camera 30.

System 10 includes a viewing configuration characterizing module 45 for calculating parameters characterizing a viewing configuration by analysis of elements 50 and 55 of scene 12 as captured by camera 12 in accordance with the first video stream. System 10 includes a video stream shaping module 60 for shaping a video stream for binocular 3D viewing, and video stream receiver 65 for receiving the first video stream from video camera 30 or a video archive 70. In one example, the shaping is effecting spectral content or color of the frame and the viewer has for each eye a different color glass. In other example the shaping is effecting polarization, and the viewer has for each eye a different polarizer glass.

System 10 feeds a client viewing system 75 using a viewer interface 77, which either feeds the client directly or through a video provider 80, a broadcasting utility, for example. Client viewing system has a display 82, a TV set for example, and a local processor 84, which may perform some final processing as detailed below. In one example, the client viewing system is a personal computer or a laptop computer having a screen as display 82 and operating system for local processing. The video provider 80 in such a case may be a website associated with or operated by system 10 or its owner.

For off-line processing of video stream from archive 70, and even for real time processing, a human intervention may be needed from time to time. For this aim, system 10 includes an editing interface 86 linked to an editing monitor 88 operated by a human editor.

A method 200 for generating a three-dimensional representation of a scene 12 is illustrated in the flow chart of FIG. 2. Method 200 includes a step 225 of providing or synthesizing video streams compatible with capturing scene 12 by cameras 40 and 30, and step 235 of generating an integrated video stream enabling three-dimensional display of the scene by integration of two video streams, the first video stream from camera 30 and one of the provided video streams fitting virtual camera 35, for example.

Synthesizing video streams fitting virtual camera 35, may be facilitated by knowing parameters of the set of viewing configuration associated with the first video stream, building a depth map, or other suitable representation such as surface equations, of scene elements 50 and 55, and finally transforming the frames of the first video stream to fit viewing configurations of camera 35. For knowing the viewing configuration parameters, the method includes a step 210 of measuring parameters of the viewing configurations, using sensing device 40. Alternatively, the method includes step 215 of using pattern recognition for analysis of scene elements 50 and 55, and consequently, a step 220 of calculating parameters of the viewing configurations by analysis of the recognized elements. Known geometrical parameters of scene elements 50 and 55 may be used for calculating the viewing configuration parameters. Sometimes, a rough estimate of the element geometrical configuration is sufficient for that calculation. Once the parameters of the viewing configurations associated with the first video stream are known, it is possible to determine in step 221 parameters of a different set of viewing parameters associated with a desired video stream that enable 3D viewing.

The method also includes the step 230 of shaping a video stream, such that upon integrating the shaped video stream with another video stream, and displaying the integrated video stream to a viewer having viewing system 75 and binocular viewing capability, the viewer senses a 3D scene.

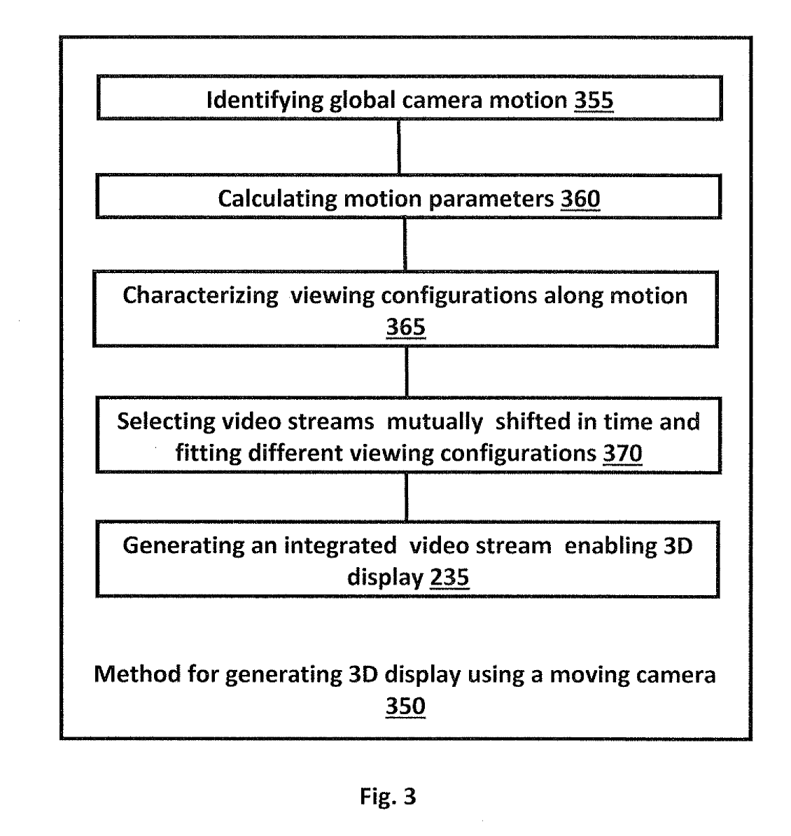

### A Method Embodiment for Generating a 3D Display Using a Moving Camera (FIG. 3)

In a preferred embodiment, real time-shifted frames are used for a stereo view. This method, known in the prior art [ref. 13], is quite effective in sports events as the shooting camera is performing a translational motion during extended periods of time. In system 10 of FIG. 1a, video stream receiver 65 includes a video buffer to store the recent video frames and uses the most convenient one as the stereo pair. The camera motion measured by sensing devices 40 as well as the lens focal length measured by a zoom sensor are used to point at the most “stereo appropriate” past frame at the video storage buffer.

In other words, camera 30 may move for a certain time period in a route such that two frames taken in a certain time difference may be used for generating a 3D perception. For example, suppose that camera 30 is moving along of the field boundary at a velocity of 600 cm/sec, while shooting 30 frames/sec. Thus, there is a location difference of 20 cm and a ( 1/30) sec time difference between each consecutive frames. Taking three frames apart, one gets a 60 cm location difference which is enough for getting 3D perception. The location difference is related to a ( 1/10) sec difference, which is short enough for the stereo image pair to be considered as captured at the same time.

To make use of such camera movements, system 10 includes a global camera motion module 20 as the synthesizing module or as a part thereof. Module 20 identifies in step 355 global camera motion during a certain time period, calculates in step 360 parameters of the motion, and characterizes in step 365 viewing configuration relating to a time within the certain time period. That step is based on characterized viewing configuration relating to another time within the certain time period. Then, in step 370 module 20 selects video streams mutually shifted in time such that the integrated video stream generated in step 235 includes superimposed video streams having different viewing configurations at a time, thus being able to produce 3D illusion.

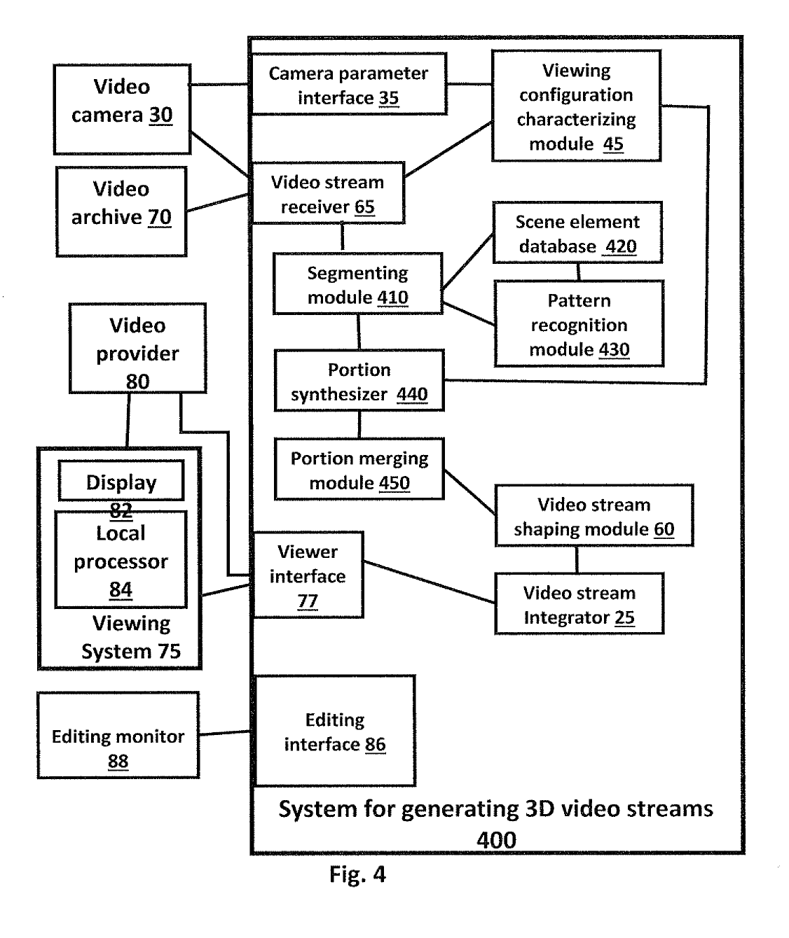

### A Sport Scene Embodiment (FIGS. 4-8)

Reference is now made to FIG. 4 which illustrates a block diagram of a system 400 for generating 3D video streams of a sport event. System 400 includes a segmenting module 410 for segmenting a scene element 50 appearing in a frame from a rest portion of a frame, element 55 for example. Such segmenting is facilitated by chromakeying, lumakeying, or dynamic background subtraction, for example. Additionally, such segmenting is facilitated by detecting field lines and other markings by line detection, arc detection or corner detection.

To facilitate elemental analysis, system 400 includes a scene element database 420 and a pattern recognition module 430 for recognizing a scene element 50 based on data retrieved from scene element database 420, and for calculating viewing configuration parameters in accordance with the recognized element and with the element data.

In a sport event, a sport playing field or its part is included in scene 12, and the field known geometrical parameters may be stored in scene element database 420 and used for calculating viewing configuration parameters. Pattern recognition module 430 is used for recognizing a part of the sport playing field, as further elaborated below.

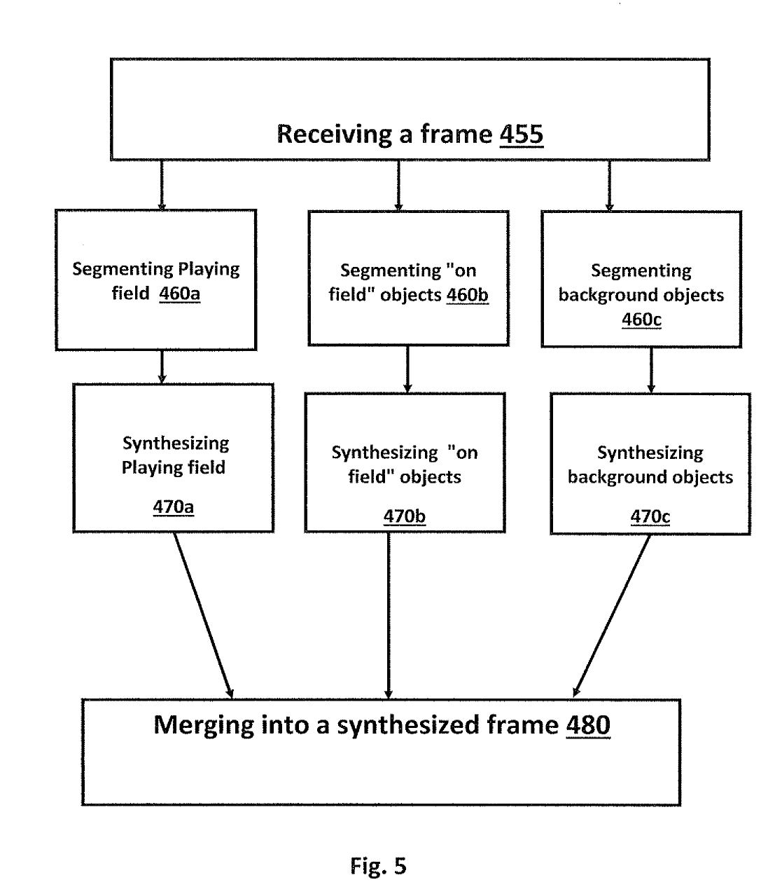

In addition to a playing field, scene 12 also includes on-field objects and background objects. Segmenting module 410 segments a frame to portions including separately the playing field, the on-field objects and the background objects. Consequently, portion synthesizer 440 associates each portion to the different viewing configuration, and portion merging module 450 merges the portions into a single frame, as illustrated in FIG. 5. The process includes a step 455 of receiving a frame, parallel steps 460a, 460b and 460c for segmenting the portions, parallel steps 470a, 470b and 470c for synthesizing appropriate respective portions, and a step 480 of merging the portions into a synthesized frame.

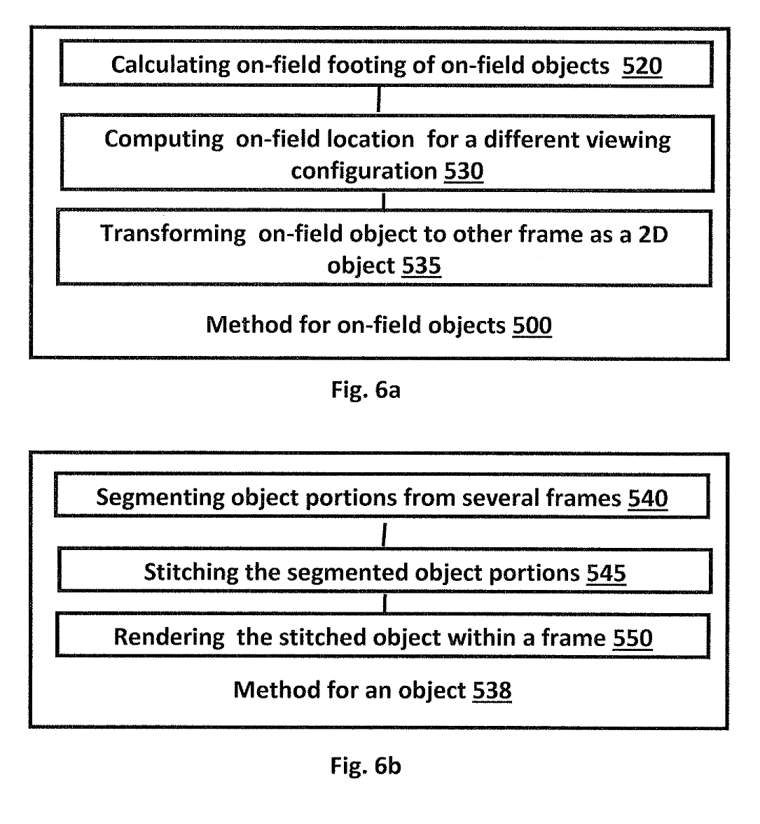

A flow chart of a method 500 for dealing with on-field objects is shown in FIG. 6a. Method 500 includes a step 520 of calculating of on-field footing locations of on-field objects in a certain frame of the first video stream, a step 530 of computing of on-field footing locations of on-field objects in a respective frame associated with a different viewing configuration, and a step 535 of transforming the on-field object from the certain frame to the respective frame as a 2D object. Such a transformation is less demanding than a full 3D transformation of the object.

Another method 538 to take care of an on-field object is depicted in the flow chart of FIG. 6b. Method 538 includes a step 540 of segmenting several portions of the object from several frames of the first video stream, a step 545 of stitching the portions of the object together to fit a different viewing configuration, and a step 550 of rendering the stitched object within a synthesized frame associated with the different viewing configuration. Such stitching is usually required for creating the virtual camera view since due to stereoscopic parallax, that view exposes object parts that are not visible in the real camera view. As past or future frames of the first video stream may contain these parts, the object must be tracked either backward or forward to capture the missing parts from at least one forward or one backward video frames and to stitch them into one coherent surface.

Similarly, a playing object like a ball may be treated by segmenting it, providing its location at the playing object, and generating a synthesized representation of the playing object for merging into a synthesized frame fitting the different viewing configuration.

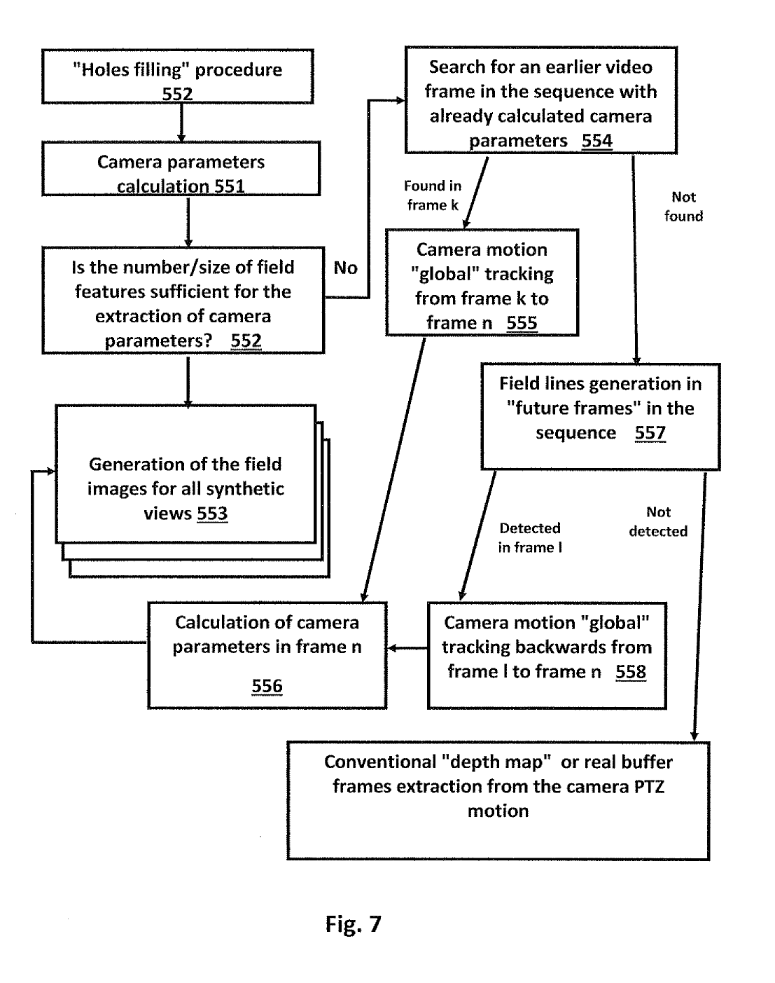

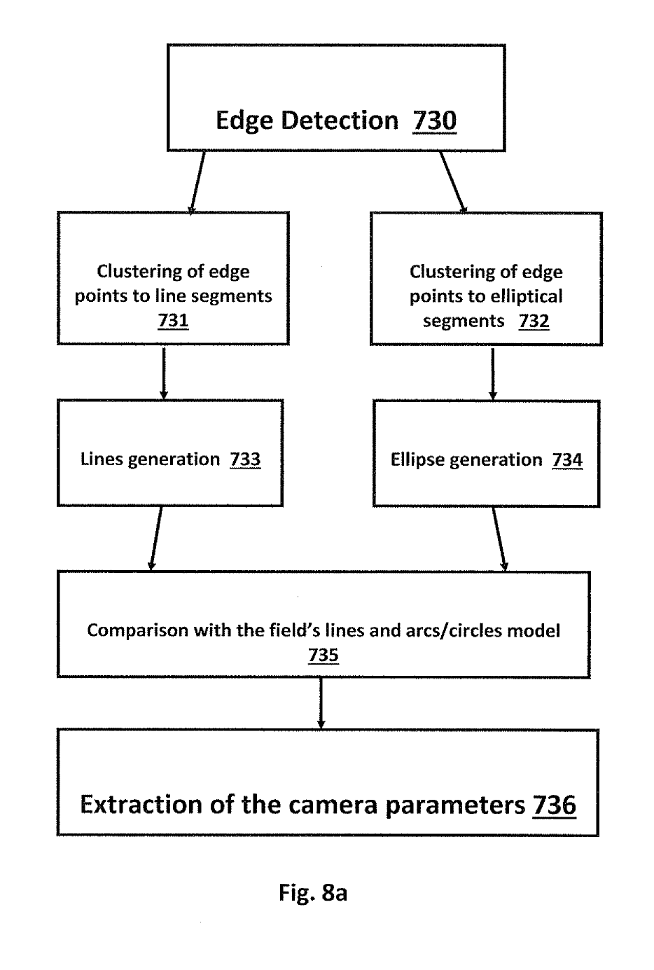

Reference is now made to FIGS. 7-8, dealing with using image processing software to convert a single conventional video stream of sports events into a three dimensional representation. The image processing module may contain some of the modules of system 400 like pattern recognition module 430, segmenting module 410 and portion synthesizer 440. It may be implemented on a personal computer, a processing board with either a DSP (digital signal processing) and/or FPGA (field programmable gate array) components, or on a dedicated gate array chip. The image processing module and may be inserted in any location on the video path, starting with the venue, the television studio, the set-top box or on the client television set 75.

The description of FIG. 7 of refers to a video sequence generated by one camera shooting a sports event, soccer for the sake of illustration. Typically there are multiple cameras deployed at a given venue to cover an event. The venue producer normally selects the camera to go on air. Automatic identification of a new sequence of frames related to a new camera going on air (a “cut” or other transition) has been proposed in the prior art [ref. 5] using global image correlation methods, and system 400 includes such means.

The method proposed in this embodiment, illustrated in FIG. 5, is based on frame segmentation in steps 460a, 460b and 460c into respective three object categories or portions, the playing field, on-field objects and background objects. The on-line objects are players, referees and a ball or other playing object. The remote background objects, typically confined to image regions above the playing field, are mainly balconies and peripheral billboards. Note that the ball may also appear against the background, once it is high enough.

The typical playing field has a dominant color feature, green in soccer matches, and a regular bounding polygon, both being effective for detecting the field area. In such a case, a chromakeying [ref. 6] is normally the preferred segmentation procedure for objects against the field background. In other cases, like ice skating events a lumakey process [ref. 7] may be chosen. In cases that the playing field does not have a dominant color or a uniform light intensity, for areas inside the field that have different colors such as field lines and other field markings, and for background regions outside the field area, other segmentation methods like dynamic background subtraction provide better results.

The partial images associated with the three object categories are separately processed in steps 470a, 470b and 470e to generate the multiple stereo views for each image's component. The image portions for each view are then composed or merged into a unified image in step 480.

FIG. 7 illustrates the processing associated with each object's category. Regarding the playing field, the first step illustrated in FIG. 7 (step 552) is aimed at “filling the holes” generated on the playing field due to the exclusion of the “on-field” objects. This is done for each “hole” by performing “global camera motion” to the frame where this “hole region” is not occluded by a foreground object. The global camera motion can be executed using the well known “block matching method” [ref. 8] or other “feature matching” [ref. 9] or optical flow methods. The “hole content” is then mapped back onto the processed frame.

In the next step, illustrated in FIG. 8a, the camera parameters like pan angle, tilt angle and lens focal length for the processed video frame are extracted. For extracting, searching is made for marking features such as lines and arcs of ellipses on the segmented field portion of the frame. The parameters of the shooting camera are then approximated by matching the features to a soccer field model. The first step, 730 in FIG. 8a, is edge detection [ref. 10], or identifying pixels that have considerable contrast with the background and are aligned in a certain direction. A clustering algorithm using standard connectivity logics is then used, as illustrated in steps 731 and 732 in FIG. 8a, to generate either line or elliptical arc segments corresponding to the field lines, mid-circle or penalty arcs of the soccer field model. The segments are then combined, in steps 733 and 734, to generate longer lines and more complete arcs of ellipses.

The generated frame's lines and arcs, 860 in FIG. 8b, are then compared to the soccer field model 855 to generate the camera parameters, pan angle, tilt angle and focal length as illustrated in steps 735 and 736 of FIG. 8a. The algorithm for conversion of detected lines/arcs to the field model to extract the camera parameters, including the pre game camera calibration, is known in the prior art and is described for example in ref. 11.

The camera parameters are then reciprocally used to generate, in step 553, synthetic field images of each requested view required for the 3D viewing, wherein a new camera location and pose (viewing configuration) are specified, keeping the same focal length.

Sometimes, either the number or the size of the field features (lines, arcs) detected in the processed frames is not sufficient to solve the set of equations specified by the above algorithm. To provide a solution for such cases, a process is used as illustrated in FIG. 7. In step 554, a prior frame k having sufficient field features for the extraction of the camera parameters is searched for in the same video sequence. These extracted parameters are already stored in system 400. The next step, step 555 of FIG. 7, is global tracking of the camera motion from frame k to current frame n. This global image tracking is using either the well known “block matching” method or potential other appropriate methods like feature matching or optical flow techniques [ref. 12]. The camera parameters for frame n are then calculated in step 556 based on the cumulative tracking transformation and the camera parameters of frame k.

In the case that no such earlier frame k has been found, system 400 executes a forward looking search as illustrated in steps 557, 558 and 556 of FIG. 7. Forward looking search is possible not only in post production but also in live situations where the 2D to 3D conversion is done on-line in real time. A small constant delay is typically allowed between event time and display time, affording a “future buffer” of frames. The future processing is identical to the processing of frame n as described in FIGS. 7 and 8a, and the global camera tracking is now executed from the “future frame” l wherein camera parameters were successfully extracted backwards to current frame n.

For convenience or for saving computing time, the past or future frames may be used even if the number and size of the field features is sufficient for successful model comparison and calculation of the camera parameters.

Regarding on-field objects, to know the positions of the players/referees on the field system 400 detects the footing points of the players/referees and projects them onto the model field in the global coordinate system. For each required synthetic view, the camera location and pose are calculated and the players/referees footing points are back projected into this “virtual camera” view. A direct transformation from the real camera's coordinate system to the synthetic camera's coordinate system is also possible. The players are approximated as being flat 2D objects, vertically positioned on the playing field and their texture is thus mapped into the synthetic camera view using a perspective transformation. Perspective mapping of planar surfaces and their textures are known in prior art and are also supported by a number of graphics libraries and graphics processing units (GPUs).

In the case that not even a single frame with sufficient field features has been found in either the past or the future searches, other 2D to 3D conversion methods known in the art [refs. 3,4] are used. In special, use may be made of techniques based on global camera motion extraction to generate depth maps, and consequently either choosing real, time-shifted frames as stereo pairs or creating synthetic views based on depth map.

For a sports scene embodiment, specific relations between scene elements may be used for calculating the viewing configuration parameters. For example, it may be assumed that referees and even players are vertical to the playing field, balconies are at a slope of 30° relative to playing field, and billboards are vertical to the playing field. Similarly, an estimated height of a scene element may be used for calculating the viewing configuration parameters. Relevant scene elements are players, billboards and balconies.

In one specific embodiment, the respective sizes of players at different depths are used to obtain a functional approximation to the depth, and as stereo disparity is linearly dependent upon object depth, such functional approximation is readily converted into a functional approximation of disparity.

The latter case suggests a simplified method of synthesizing the second view, in which surface disparity values are obtained directly from the functional approximation described above. The functional approximation depends on 2D measurements of the real image location and other properties (such as real image height).

To support a significant depth perception by the virtual view, on-field objects must be transformed differently than the field itself or other backgrounds such as the balconies. Also, objects positioned in different depths are transformed differently which may create “holes” or missing parts in other objects. According to one embodiment, the system stitches objects' portions being exposed in one frame to others visible in other frames. This is done by means of inter-frame block matching or optical flow methods. When a considerable portion of the object's 3D model is constructed it may be rendered for each synthetic view to generate more accurate on field objects views.

To estimate the ball position in each synthetic stereo view, system 400 first estimates the ball position in a 3D space. This is done by estimating the 3D trajectory of the ball as laying on a plane vertical to ground between two extreme “on-field” positions. The ball image is then back projected from the 3D space to the synthetic camera view at each respective frame.

Finally, regarding background objects, the balconies and billboards are typically positioned on the upper portion of the image and according to one embodiment are treated as a single remote 2D object. Their real view is mapped onto the synthetic cameras' views under these assumptions.

Alternatively, the off-field portions of the background can be associated with a 3D model which comprises two or more surfaces, that describes the venue's layout outside the playing field. The 3D model may be based on actual structural data of the arena.

In another preferred embodiment of the current invention, pan, tilt and zoom sensors mounted on the shooting cameras are used to measure the pan and tilt angles as well as the camera's focal length in real time. In certain venues such sensors are already mounted on the shooting cameras for the sake of the insertion of “field attached” graphical enhancements and virtual advertisements [ref. 13]. The types of sensors used are potentiometers and encoders. When such sensors are installed on a camera there is no need to detect field features and compare them with the field model since the pan, tilt and zoom parameters are available. All other processes are similar to the ones described above.

In a preferred embodiment, real time-shifted frame is used as a stereo view, as mentioned above in reference to FIG. 3. This method, known in the prior art [ref. 13], is quite effective in sports events as the shooting camera is performing a translational motion during extended periods of time. The system of this embodiment comprises a video buffer to store the recent video frames and uses the appropriate stored frames as stereo pairs. For example, the motion sensor's output as well as the lens focal length may be used to point at the most “stereo appropriate” past frame at the video storage buffer.

Another preferred embodiment uses the same field lines/arcs analysis and/or global tracking as described in reference to FIGS. 7-8 to choose the most “stereo appropriate” frame to be used as the stereo pair of the current processed frame.

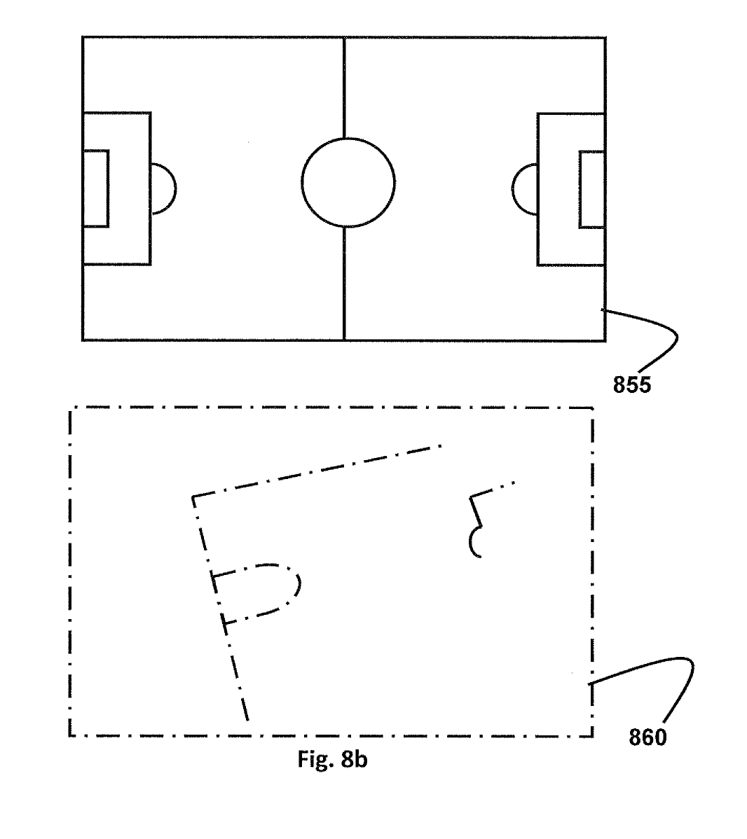

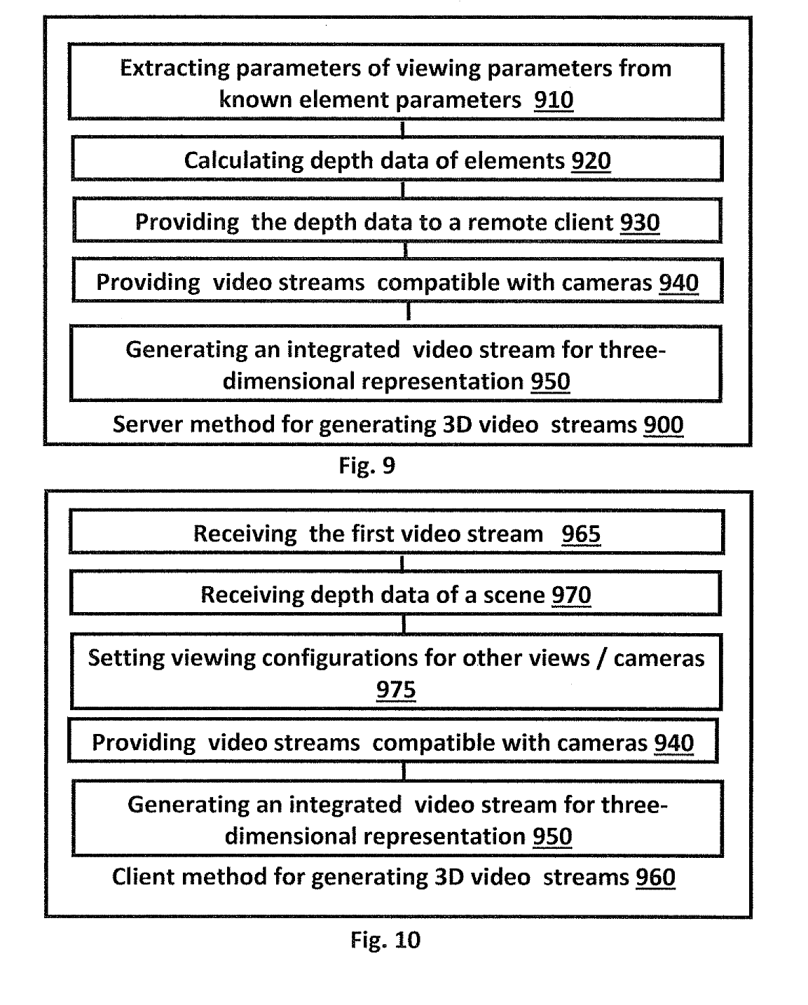

### A Method for Generating 3D Video Streams in Server-Client Cooperation (FIGS. 9-10)

Rather than client getting a final integrated video stream, it is possible that part of the preparation of the final integrated video stream is done in the client viewing system 75 of FIG. 1a, using a local processor 84. Referring now to FIG. 9, a method 900 for generating a three-dimensional representation of a scene 12 is described by a flow chart. Scene 12 includes an element having known spatial parameters. Method 900 includes a step 910 of extracting parameters of the first set of viewing configurations using the known spatial parameters, and a step 920 of calculating depth data relating to the scene elements based on the first video stream, and based on the extracted parameters. Then, the method includes the step 930 of providing the depth data to a remote client, who uses that data for providing, in step 940, video streams compatible with capturing the scene by cameras, and generates, in step 950, an integrated video stream enabling three-dimensional display of the scene by integration of two video streams having mutually different sets of viewing configurations.

The depth data may be transmitted in image form, wherein each pixel of the real image is augmented with a depth value, relative to the real image viewing configuration. In another embodiment, the depth information is conveyed in surface form, representing each scene element such as the playing field, the players, the referees, the billboards, etc. by surfaces such as planes. Such representation allows extending the surface information beyond the portions visible in the first image, by a stitching process as described above, thereby supporting viewing configurations designed to enhance the stereoscopic effect.

A client method 960, as described by the flow chart of FIG. 10, includes step 965 of receiving the first video stream, a step 970 receiving the intermediate set of data relating to the scene, a step 975 of setting viewing configurations for other views/cameras, a step 940 of using the intermediate set of data for providing video streams compatible with capturing the scene by cameras, and step 950 of generating an integrated video stream enabling three- dimensional display of the scene by integration of video streams.

Note that according to step 935, the remote client may determine the surface of zero parallax of the 3D images such that the 3D image appears wherever desired, behind a screen, nearby to the screen or close to a viewer. This determination is accomplished by deciding on the distance between the real camera and virtual camera and on their viewing directions relative to scene 12, as known in the art. Step 975 may also be executed implicitly by multiplying the views' disparity values by a constant, or a similar adjustment. A major advantage of such embodiment is that a viewer may determine the nature and magnitude of the 3D effect as not all viewers perceive 3D in the same manner. In one embodiment, the distance between the cameras, and the plane of zero parallax are both controlled by means of an on-screen menu and a remote control.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

In particular, the present invention is not limited in any way by the examples described. In a specific example, the invention can be applied to more than one captured video stream, for the purpose of generating multiple additional views as required by auto-stereoscopic displays. In that case, stereoscopic vision techniques for depth reconstruction, as known in prior art, may be used to provide depth values that complement or replace all or part of the depth values computed according to the present invention. In another specific example, the invention may be used to correct or enhance the stereoscopic effect as captured by said more than one video stream, as described above: change the surface of zero parallax, the distance between the cameras, or other parameters.

1-43. (canceled)

44. A method for generating a three-dimensional representation of a scene, the scene being represented by a first video stream captured by a certain camera at a first set of viewing configurations, the method comprising:
(a) providing one or more video streams representing the scene from viewpoints of one or more cameras, each camera having a respective set of viewing configurations different from the first set of viewing configurations; and
(b) generating an integrated video stream enabling three-dimensional display of the scene by integration of at least two video streams selected from the group of video streams consisting of the first video stream and the one or more provided video streams, the sets of viewing configurations related to the selected video streams being mutually different.

45. The method of claim 44 wherein a viewing configuration of a camera capturing said scene is characterized by one or more parameters of the group of parameters consisting of parameters of geographical viewing direction, parameters of geographical location, parameters of viewing direction relative to one or more elements of said scene, parameters of location relative to one or more elements of said scene, and parameters relating to a lens of the camera.

46. The method of claim 44 wherein parameters characterizing a viewing configuration of said first camera are measured by at least one device of the group of devices consisting of encoders mounted on motion mechanisms of said first camera, potentiometers mounted on motion mechanisms of said first camera, a global positioning system device, an electronic compass associated with said first camera, encoders mounted on lens mechanisms of said first camera, and potentiometers mounted on lens mechanisms of said first camera.

47. The method of claim 44 wherein the method further includes the step of calculating one or more parameters characterizing a viewing configuration by analysis of elements of said scene as captured by said certain camera in accordance with said first video stream.

48. The method of claim 47 wherein known geometrical parameters of a certain element of the scene are used for calculating the viewing configuration parameters.

49. The method of claim 47 wherein the method includes determining a set of viewing configuration different from the respective set of viewing parameters associated with said first video stream.

50. The method of claim 47 wherein at least one frame is synthesized directly from a respective frame of the first video stream by two-dimensional transformation of at least one surface depicted in said respective frame.

51. The method of claim 48 wherein at least a part of a sport playing field is a major part of said scene, and known geometrical parameters of said sport playing field are used for calculating viewing configuration parameters.

52. The method of claim 51 wherein the method further include using at least one pattern recognition technique for recognizing at least one part of said sport playing field and calculate viewing configuration parameters.

53. The method of claim 44 wherein the method includes:
(I) identifying global camera motion during a certain time period;
(II)calculating parameters of the motion; and
(III)characterizing viewing configuration relating to a time within said certain time period based on characterized viewing configuration relating to another time within said certain time period.

54. The method of claim 44 wherein the method further includes the step of shaping at least one selected video stream such that upon integrating the selected video streams and displaying said integrated video stream to a viewer having viewing capability corresponding to said shaping, a three dimensional scene is sensed by the viewer.

55. The method of claim 54 wherein said shaping is effecting spectral content of the frames , wherein said viewer has for each eye a different color glass.

56. The method of claim 54 wherein the consecutive frames of at least two video streams are arranged alternately in accordance with appropriate display and view system.

57. The method of claim 44 wherein the first camera captures said first video stream while in motion, and at least one selected video stream is a video stream captured by said first camera at timing shifted relative to said first video stream, such that the generated video stream includes superimposed video streams representative of different viewing configurations at a time.

58. The method of claim 44 wherein the method includes synthesizing frames of at least one video stream by associating a frame of said first video stream having certain viewing configuration to a different viewing configuration, whereas at least major portion of contents of said frame of said first video stream are modified to fit said different viewing configuration, and the different viewing configuration is selected for enabling three- dimensional display of said scene.

59. The method of claim 58 wherein the method further includes the step of segmenting an element of the scene appearing in a frame from a rest portion of a frame.

60. The method of claim 59 wherein segmenting is facilitated by at least one technique of a group of techniques consisting of chromakeying, lumakeying, dynamic background subtraction, field line detection, and on-field marking detection.

61. The method of claim 59 wherein said scene is a sport scene including a playing field, a group of on-field objects and a group of background objects, and the method includes segmenting of a frame at least one of the playing field, the group of on-field objects and the group of background objects.

62. The method of claim 61 wherein the method includes the steps of:
(i) separately associating to said different viewing configuration at least one portion of a segmented playing field, a segmented group of on-field objects and a segmented group of background objects; and
(ii) merging into a single frame at least one of the associated segmented portions.

63. The method of claim 62 wherein the method includes the steps of :
(iii) calculating of on-field footing locations of on-field objects in a certain frame of said first video stream;
(iv) computing of on-field footing locations of on-field objects in a respective frame associated with a different viewing configuration.

64. The method of claim 63 wherein the method includes the step of:
(v) transforming at least one object of said on-field objects from said certain frame to said respective frame as a two-dimensional object.

65. The method of claim 63 wherein the method includes synthesizing at least one object of said on-field objects by the steps of:
(vi) segmenting two or more portions of the object from respective two or more frames of said first video stream;
(vii) stitching together said two or more portions of the object to fit said different viewing configuration; and
(viii) rendering the stitched object within a synthesized frame associated with said different viewing configuration.

66. The method of claim 61 wherein a playing object is used in said sport scene and the method includes the steps of:
(A) segmenting the playing object;
(B) providing location of the playing object; and
(C) generating a synthesized representation of the playing object for merging into a synthesized frame fitting said different viewing configuration.

67. The method of claim 61 wherein at least one field line of the playing field is used for at least one step of the group of steps consisting of:
(A) calculating at least one viewing configuration parameter of the certain camera; (B) segmenting at least one playing object; and
(C) transforming the playing field onto the synthesized frame.

68. The method of claim 61 wherein an estimated height of a scene element is used for calculating the viewing configuration parameters, the scene element is selected from the group of sport scene elements consisting of players, billboards and balconies.

69. The method of claim 59 wherein the method includes detecting one or more playing field features in a certain frame of said first video stream, and upon absence of sufficient feature data for said detecting, other frames of the first video stream are used as a source of data to facilitate said detecting.

70. A system for generating a three-dimensional representation of a scene, the scene being represented by a first video stream captured by a certain camera at a first set of viewing configurations, the system comprising:
(a) a synthesizing module adapted for providing one or more video streams representing the scene from viewpoints of one or more cameras, each camera having a respective set of viewing configurations different from the first set of viewing configurations; and
(b) a video stream integrator adapted for generating an integrated video stream enabling three-dimensional display of the scene by integration of at least two video streams selected from the group of video streams consisting of the first video stream and the one or more provided video streams, the streams of viewing configurations related to the selected video streams being mutually different.

71. The system of claim 70 wherein the system further includes a camera parameter interface adapted for receiving parameters characterizing a viewing configuration of said first camera from at least one device relating to the first camera.

72. The system of claim 70 wherein the system further includes a viewing configuration characterizing module adapted for calculating one or more parameters characterizing a viewing configuration by analysis of elements of said scene as captured by said certain camera in accordance with said first video stream.

73. The system of claim 70 further including a scene element database and a pattern recognition module adapted for recognizing at least one part of a scene element based on data retrieved from said scene element database and calculate viewing configuration parameters in accordance with the recognizing and the element data.

74. The system of claim 70 wherein the system further includes a global camera motion module adapted for at least one of:
(I) identifying global camera motion during a certain time period;
(II)calculating parameters of the motion; and
(III)characterizing viewing configuration relating to a time within said certain time period based on characterized viewing configuration relating to another time within said certain time period.
(IV) time shifting a video stream captured by said first camera relative to said first video stream, such that the generated video stream including superimposed video streams having different viewing configurations at a time.

75. The system of claim 70 wherein the system further includes a video stream shaping module adapted for shaping at least one selected video stream such that upon integration of the selected video streams and displaying said integrated video stream to a viewer having viewing capability corresponding to said shaping, a three dimensional scene is sensed by the viewer.

76. The system of claim 70 wherein the synthesizing module is adapted to synthesize frames of at least one video stream by associating a frame of said first video stream having certain viewing configuration to a different viewing configuration, whereas at least major portion of contents of said frame of said first video stream are modified to fit said different viewing configuration, and the different viewing configuration is selected for enabling three-dimensional display of said scene.

77. The system of claim 76 wherein the system further includes a segmenting module adapted for segmenting an element of the scene appearing in a frame from a rest portion of a frame.

78. The system of claim 77 wherein said scene is a sport scene including a playing field, a group of on-field objects and a group of background objects, and the system includes:
(i) a portion synthesizer adapted for separately associating to said different viewing configuration each of a segmented playing field, a segmented group of on-field objects and a segmented group of background objects; and
(ii) a portion merging module adapted for merging into a single frame the associated segmented playing field, the associated segmented group of on-field objects and the associated segmented group of background objects.

79. The system of claim 70 wherein at least one part of the system is located at one location of the group of locations consisting of:
(i) a location within 1 km of the first camera;
(ii) a broadcast studio broadcasting said scene in real time; and
(iii) a location in close vicinity of a consumer viewing system.

80. The system of claim 70 wherein the system is implemented on a processing board comprising at least one of a field programmable gate array and a digital signal processor.

81. A method for generating a three-dimensional representation of a scene including at least one element having at least one known spatial parameter, the scene being represented by a first video stream captured by a certain camera at a first set of viewing configurations, the method comprising:
(a) extracting parameters of the first set of viewing configurations using the at least one known spatial parameter of the certain element; and
(b) calculating intermediate set of data relating to the scene based on the first video stream, and on the extracted parameters of the first set of viewing configurations.

82. The method of claim 81, wherein said irate mediate set of data includes depth data of one or more elements of the scene.

83. The method of claim 81 wherein the method further includes:
(c) using said intermediate set of data for synthesizing one or more video streams compatible with capturing the scene by one or more cameras, each camera having a respective set of viewing configurations different from the first set of viewing configurations; and
(d) generating an integrated video stream enabling three-dimensional display of the scene by integration of at least two video streams selected from the group of video streams consisting of the first video stream and the one or more synthesized video streams, the sets of viewing configurations related to the selected video streams being mutually different.

84. The method of claim 81, wherein the method further includes the step of:
(c) providing said intermediate set of data to a remote client for:
(A) using said intermediate set of data for providing one or more video streams compatible with capturing the scene by one or more cameras, each camera having a respective set of viewing configurations different from the first set of viewing configurations; and
(B) generating an integrated video stream enabling three-dimensional display of the scene by integration of at least two video streams selected from the group of video streams consisting of the first video stream and the one or more provided video streams, the sets of viewing configurations related to the selected video streams being mutually different.

85. A client method for generating a three-dimensional representation of a scene including at least one element having at least one known spatial parameter, the scene being represented by a first video stream captured by a certain camera at a first set of viewing configurations, a server associated with a client extracting parameters of the first set of viewing configurations using the at least one known spatial parameter of the certain element, and calculating intermediate set of data relating to the scene based on the first video stream, and on the extracted parameters of the first set of viewing configurations, the client method comprising:
(a) receiving the intermediate set of data relating to the scene; and
(b)using said intermediate set of data for providing one or more video streams compatible with capturing the scene by one or more cameras, each camera having a respective set of viewing configurations different from the first set of viewing configurations; and
(c) generating an integrated video stream enabling three-dimensional display of the scene by integration of at least two video streams selected from the group of video streams consisting of the first video stream and the one or more provided video streams, the sets of viewing configurations related to the selected video streams being mutually different.

86. The client method of claim 85 wherein the method further includes receiving the first video stream.
